(19) United States
(12) Patent Application Publication
(10) Pub. No.: US 2007/0219799 A1
(43) Pub. Date: Sep. 20, 2007

(54) Text to speech synthesis system using syllables as concatenative units

(76) Inventors: Inci Ozkaragoz, Torrance, CA (US); Benjamin Ao, Torrance, CA (US); William Arthur, San Juan Capistrano, CA (US)

Correspondence Address: MURAMATSU & ASSOCIATES, Suite 310, 114 Pacifica, Irvine, CA, 92618, US

(21) Appl. No.: 11/647,824

(22) Filed: Dec. 30, 2006

Related U.S. Application Data
(60) Provisional application No. 60/755,410, filed on Dec. 30, 2005.

(51) Int. Cl. G10L 13/08

(52) U.S. Cl. 704/260

(57) ABSTRACT

The invention, in its several embodiments, pertains to methods and apparatuses for text to speech synthesis. In embodiments, the method can include obtaining text of a word having a first syllable and a second syllable, providing from a database a first voice recording of the first syllable, providing from the database a second voice recording of the second syllable, combining by a processor the first voice recording and the second voice recording, and transmitting the combination of the first voice recording and the second voice recording over an audio speaker. In embodiments, the apparatus can include a database, an audio speaker and a processor connected to the database and speaker. The processor is capable of performing the steps of generating text of a word having at least a first syllable and a second syllable, obtaining from the database a first voice recording of the first syllable and a second voice recording of the second syllable, combining the first and second voice recordings, and transmitting the combination over the audio speaker.

This application claims the benefit of U.S. Provisional Patent Applications Ser. No. 60/755,410 filed Dec. 30, 2005, entitled “TEXT TO SPEECH SYNTHESIS SYSTEM USING SYLLABLES AS CONCATENATIVE UNITS” by Ozkaragoz, et al., which is hereby incorporated by reference herein for all purposes.

### FIELD OF THE INVENTION

The technology disclosed by this application is related to a text to speech synthesis. More specifically in embodiments to text to speech synthesis using a concatenative processes in which syllables and supersyllables are used as concatenative units.

### BACKGROUND ART

Text-to-speech synthesis technology gives machines the ability to convert arbitrary text into audible speech, with the goal of being able to provide textual information to people via voice messages. Key target text to speech synthesis applications in communications include: voice rendering of text-based messages such as email or fax as part of a unified messaging solution, as well as voice rendering of visual/text information (e.g., web pages). In the more general case, text to speech synthesis systems provide voice output for all kinds of information stored in databases (e.g., phone numbers, addresses, vehicle navigation information) and information services (e.g., restaurant locations and menus, movie guides, etc.). Ultimately, given an acceptable level of speech quality, text to speech synthesis systems could also be used for reading books (i.e., Talking Books) and for voice access to large information stores such as encyclopedias, reference books, law volumes, etc.

In certain applications such as mobile or portable devices, the text-to-speech systems have been limited by both the processing power and data storage capacity of the devices. As such, a need exists for text to speech device and/or method which provides an acceptable level while minimizing the processing and data storage needed.

### SUMMARY OF THE INVENTION

In embodiments, the present invention includes a method of text to speech synthesis which can be used in a vehicle navigation system. The method can include the steps of obtaining text of a word having a first syllable and a second syllable, providing from a database a first voice recording of the first syllable, providing from the database a second voice recording of the second syllable, combining by a processor the first voice recording and the second voice recording, and transmitting the combination of the first voice recording and the second voice recording over an audio speaker.

Depending on the embodiment, the vehicle navigation system can in a simple form include a database, a processor connected to the database and an audio speaker connected to the processor. In turn, the database can comprise a map having at least one map element and having multi-syllable text associated to the map elements. As such, the step of obtaining text of a word having a first syllable and a second syllable can include providing from the database multi-syllable text associated to the map elements.

The combination of the first voice recording and the second voice recording which is played over the audio speaker can provide an expression of sound which is at least substantially similar to a verbal rendition of the original word.

In addition to the multisyllable words being obtained from database, the processor of the navigation system is also capable of generating various text of multi-syllable words. In addition, the multi-syllable word generated by the processor can be part of a navigation command generated by the system processor. Such navigation commands can be capable of aiding navigation of the vehicle.

In embodiments, syllable context can be determined by using the text of the word to define whether the syllable is bound by a vowel. This syllable context is then used to provide from the database a voice recording of the syllable recorded in the same context. The syllable context can include whether the syllable is preceded or followed by a vowel or a consonant.

The present invention can also include an apparatus, such as a vehicle navigation apparatus system. The navigation apparatus can include a database, one or more audio speakers and a processor connected to the database and speaker. The processor is capable of performing the steps of generating text of a word having at least a first syllable and a second syllable, obtaining from the database a first voice recording of the first syllable and a second voice recording of the second syllable, combining the first voice recording and the second voice recording, and transmitting the combination of the first voice recording and the second voice recording over the audio speaker.

### BRIEF DESCRIPTION OF THE DRAWINGS

FIG. 1 shows a diagram of an apparatus according to at least one embodiment of the present invention.

FIGS. 2A-2B show flow charts according to at least one embodiment of the present invention.

FIG. 2C shows a diagram of a method according to at least one embodiment of the present invention.

FIGS. 2D-2E show flow charts according to at least one embodiment of the present invention.

FIG. 2F shows a diagram of a method according to at least one embodiment of the present invention.

FIG. 3 shows a flowchart according to at least one embodiment of the present invention.

FIG. 4 shows a flowchart according to at least one embodiment of the present invention.

### DETAILED DESCRIPTION OF THE INVENTION

The text to speech synthesis system of the present invention incorporates a database which stores syllables and supersyllables as well as sound units created by a voice recording tool and a voice analysis tool. This application also discloses the features involved in the database for storing the syllables and sound units, the voice recording tool for recording speech sounds produced by a voice talent, and the voice analysis tool for marking-up and analyzing syllables in the phrases recorded by the voice recording tool.

A text to speech synthesis system in the conventional technology utilizes diphones, semi diphones, and phonemes as concatenative units. In contrast, one of the essential features of the text to speech synthesis system that has been developed by the inventors of this application resides in the fact the syllable and supersyllable are used as concatenative units. Syllables are combinations of phonemes.

A text to speech synthesis system using the phoneme as the concatenative unit tends to involve acoustic mismatches between vowels and consonants within the syllable. For example, it could concatenate the two phonemes “b” and “u” to produce the word “boo”. However, unless specifically designed not to do so, it could conceivably concatenate with “b” a vowel “u” that originally was recorded with a preceding “d”. Since the second formant of the naturally produced “bu” is very different from the second formant of the naturally produced “du”, the synthesized output of “bu” would not sound exactly like the original naturally produced “bu”. The text to speech synthesis system of the present invention avoids this problem since the system uses the syllable as the concatenative unit. The text to speech synthesis system would produce the synthesized syllable “bu” just as it was recorded since it was never split into phonemes. Consequently, it is possible to avoid mismatches within syllables.

The concatenative unit which is used in the present invention text to speech (TTS) synthesis system is based on a syllable-in-context construct. Since any English word can be split into syllables consisting of a vowel nucleus and adjacent consonants, the notion of the syllable as the basic concatenative unit has advantages. One of the greatest advantages of making the syllable the basic concatenative unit is that the acoustic characteristics of most consonant-vowel transitions are preserved. That is, context-conditioned acoustic changes to consonants are automatically present to a great extent when the syllable is chosen as the basic unit. However, due to the fact that the syllable inventory for English is very large and sufficient computational storage and processing capabilities must be available.

Although using the syllable as the basic concatenative unit reduces the number of acoustic mismatches between vowels and consonants within the syllable, it does not address the problem of treating coarticulation mismatches across syllable boundaries. This type of syllable boundary coarticulation can be just as important as within syllable coarticulation.

Here, the syllable coarticulation means as follows. For example, individual sounds like “b” “a” and “t” are encoded or squashed together into the syllable-sized unit “bat”. When a speaker produces this syllable, his vocal tract starts in the shape characteristic of a “b”. However, the speaker does not maintain this articulatory configuration, but instead moves his tongue, lips, etc. towards the positions that would be attained to produce the sound of “a”. The speaker never fully attains these positions because he starts towards the articulatory configuration characteristic of “t” before he reaches the steady state (isolated or sustained) “a” vowel. The articulatory gestures that would be characteristic of each isolated sound are never attained. Instead the articulatory gestures are melded together into a composite, characteristic of the syllable. There is no way of separating with absolute certainty the “b” articulatory gestures from the “a” gestures. Consequently, the “b” and the “a” are said to be coarticulated.

Syllable-in-Context Synthesis

Due to the problem of syllable boundary coarticulation stated above, the TTS System of embodiments of the present invention has stored in its TTS database every possible English syllable, and if the syllable is bounded by a vowel on at least one side, its possible linguistic context is encoded as well. Because of storage limitations, providing the linguistic context for each syllable was limited to syllables whose boundaries consisted of vowels, but not consonants. This is because, relatively speaking, more linguistic coloring occurs across vocalic boundaries than across consonantal boundaries. For example, the syllable “ba” would have linguistic context encoded for the vowel “a”, but not for the consonant “b”. The syllable-in-context construct of using the English syllable as the basic concatenative unit along with its very large inventory of linguistic context provides for a smooth synthetic output. The syllable context information is encoded for syllables beginning or ending with a vowel.

Supersyllables

As mentioned above, due to storage limitations, in embodiments only syllables with vocalic boundaries could have their linguistic context recorded and stored in a TTS database. This leaves open the possibility of coarticulation mismatches across consonantal syllabic boundaries. This is one reason why the concept of the supersyllable was created; it allows certain syllables to include more than one vowel nucleus when the syllables involve consonants that are particularly prone to coloring their adjacent linguistic context. For example, when the consonant “r” is crucially followed by an unstressed vowel, as in “terrace” shown below, the concatenative unit then includes both vowels on which the “r” hinges. Since two vowel nuclei are included in this concatenative unit, it's referred to as a supersyllable and is not divisible within the system. (Note: Unstressed vowels are indicated by the tilde ˜. The phrasal stress is indicated by the asterisk *.)

e.g. TERRACE tE*rx˜s}

Another example of a supersyllable is if two vowels appear consecutively and one is unstressed as in “spi˜a*” shown below. Typically, the unit would be split into two syllables. The decision to classify two consecutive vowels, in which one is unstressed, into a supersyllable is that there is heavy linguistic coloring between the two vowels; as such there is no exact dividing line between the vowels acoustically.

e.g. CASPIANA ka″|spi˜a*|nx˜}

VCV Structures

Since there is no objective criteria for assigning consonants to a particular vowel nucleus in certain ambiguous cases such as “letter”, embodiments of the TTS System of the present invention delineates VCV structures into V|CV. Thus, “letter” for example would be phonetically divided into “le” and “tter”, rather than “lett” and “er”, in such embodiments of the system.

Because embodiments of the TTS system of the present invention use the syllable and supersyllable as the concatenative units, the system can avoid coarticulation mismatches across syllable boundaries as noted above. When syllables are concatenated with other syllables, the linguistic context of the syllables (if ending or starting with a vowel) is taken into account in order to avoid mismatches across syllable boundaries. For example, when the syllable “pA*” is concatenated with a following syllable that starts with a “p”, as in POPLUAR pA*|plu˜A˜r], the syllable “pA*” must be selected from a class of “pA*” that all were followed by a “p” in the original recording. Similarly, the syllable “pA*” that is selected to synthesize the word PASTA pA*|stx˜] must be selected from a class of “pA*” syllables that were originally followed by an “s”. That is, the original linguistic context for “pA*” must be considered when synthesizing it with other syllables.

Phonetic Symbol Set and Phrase List

As described above, the concatenative unit in embodiments of the TTS System of the present invention is the syllable-in-context. The TTS System stores in its TTS database every possible English syllable, and if the syllable is bounded by a vowel on at least one side, its possible linguistic context is encoded as well.

Before a recording list of phrases comprising every English syllable with its phonetic transcription could be created, a phonetic symbols set has to be selected for use. The Applicants have created unique phonetic symbols set. Most of prior phonetic transcription systems had problems, such as the use of multiple letters or non-alphabetic characters to represent a single sound and the failure to make certain important distinctions. For the purposes of embodiments of the TTS system of the present invention, the phonetic symbols set needed to be easy to process computationally, as well as easy for the voice talent to learn quickly and record the phrases accurately.

Therefore, all the phonetic symbols are single alphabetic characters and easy to process. One of the ramifications of having a syllable-in-context concatenative unit is that a fewer number of phonemes are required than in systems which base their concatenative unit on the phoneme or diphone. In embodiments of the TTS system of the present invention, only 39 phonemes were selected. For example, only one type of “t” phoneme was utilized since the varied linguistic context for “t” in words such as “tea” and “steep” will already be encoded as part of the syllable unit. prosodic symbols such as the four levels of stress are diacritic. The stress levels that are represented are the unstressed, the primary stress, the phrasal stress, and the secondary stress.

In some embodiments, with the phonetic symbols set created, a recording list of is produced. In at least one example of the present invention, 120,000 phrases were produced. In creating the phrase list, a special algorithm was utilized to encompass every possible English syllable within the smallest number of phrases. Once these phrases are recorded and analyzed into concatenative units, this expertly engineered phrase list enables the Applicant's TTS system to produce any English word because the phrase list includes every possible English syllable along with their linguistic context. Some examples of phrases and their phonetic transcriptions from the phrase list are the following:

CLARYVILLE COLLISION & CUSTOMS:
kle′ri˜|vI″l]kx˜|lI′|Zx˜n]a˜nd]kx*|stx˜mx}
CLAIBORNE AT ESPLANADE SS:
kle′|bc″rn]a˜t]E′|splx˜|nA″d]E′s]E*s}
CLAYLAND IGA FOODLINER:
kle′|lx˜nd]Y′]Ji′]e′]fu*d|lY″|nR˜}
CLAYPIT HILL ELEMENTARY SCHOOL:
kle′|pI″t]hI′l]E″|lx˜|mE*n|tx˜ri˜]sku′l}
Voice Recording

In embodiments of the present invention a voice talent uses a voice recording method to record the all the phrases in the phrase list. In embodiments where the TTS system is utilized to a navigation system, the phrases are selected from a map data file which includes all of street names and point of interest (POI) names throughout the country. The Applicants have employed a greedy algorithm for selecting the phrases. The greedy algorithm is an algorithm that always takes the best immediate, or local, solution while finding an answer. Greedy algorithms find the overall, or globally, optimal solution for some optimization problems, but may find less-than-optimal solutions for some instances of other problems. If there is no greedy algorithm that always finds the optimal solution for a problem, a user may have to search (exponentially) many possible solutions to find the optimum. Greedy algorithms are usually quicker, since they don't consider the details of possible alternatives. In embodiments, the system may use a map data file such as one commercially available through a provider, for example, NAVTECH, Inc. of Monterey, Calif., USA.

The invention in embodiments can include a recording tool which displays each phrase one phrase at a time. As each phrase is recorded and saved, the recording tool automatically advances to the next phrase. The recording tool minimizes recording time and errors by automatically validating the amplitude of the recorded speech. In this way, each phrase is assured of having a consistent range in amplitude.

The recording tool also ensures that the recorded speech is not cut off at the beginning or at the end of the spoken phrase. That is, the voice talent is not allowed to advance to the next phrase if the voice talent starts to speak before turning on the toggle switch of the recording tool. In embodiments the tool also automatically places a minimum number of milliseconds of silence at both the start and end of the phrase so that the phrase can be more easily split into concatenative units at a later stage.

As stated in the phrase list section above, the voice talent must learn the phonetic symbols set in order to pronounce the phrases accurately. The recording tool displays the phonetic symbols legend for quick reference. Furthermore, in order to maximize the accuracy of reading the phrases, only the phonetic transcription is displayed on the recording tool screen. The English text is hidden from view in order to avoid having ambiguous phrases read incorrectly. For example, “record” is pronounced differently depending on whether it's construed as a noun or a verb. Abbreviations such as “St.” and “Dr.” are also ambiguous.

Once the recording session starts, a phrase to be recorded will appear in the lower panel of a split window. The pronunciation guide of this phrase appears underneath. To start recording, the voice talent can select the menu item Record|Begin, or click a button on the tool bar with the left button of your mouse, or simply press the Down Arrow on a keyboard. A red circle will appear in the upper panel indicating recording is in progress. When the voice talent finishes reading the phrase, she/he can select the menu item Record|End, or click a button on the tool bar with the left button of your mouse, or simply press the Down Arrow again on your keyboard. The waveform of the recording will appear in the upper panel.

The voice talent needs to read the phrase with a clear, steady and natural voice. If the voice is too loud or too weak, the voice talent will be prompted to read again. If the recording is good, the voice talent can move on to the next phrase by selecting the menu item Phrase|Next or clicking a button on the tool bar or simply pressing the Right Arrow on your keyboard. The recording will be automatically saved.

If it is necessary to hear a hint on the proper pronunciation of a phrase, the voice talent can select the menu item Phrase|TTS or click a button on the tool bar or simply press the Up Arrow on your keyboard. To browse recorded phrases, the voice talent can select the menu item Phrase|Previous or click a button on the tool bar or simply press the Left Arrow on your keyboard. The voice talent can select the menu item Phrase|Next or click a button on the tool bar or press the Right Arrow on your keyboard to return to the end of the recorded phrase list. To listen to a recorded phrase, the voice talent can select the menu item Record|Play or click the button on the tool bar.

Voice Analysis

Linguistic Algorithms

Embodiments of the present invention also include a method and apparatus for voice analysis. In at least one embodiment the Applicants have developed a voice analysis tool which provides an automatic syllable mark-up of all the recorded phrases. The voice analysis tool analyzes speech, one phrase at a time, by using complex linguistic algorithms to detect and mark the start and end of syllables and supersyllables which are the concatenative units. In order to create optimal mark-ups of the phrases, aside from using well known linguistic knowledge such as the second formant transition between consonants and vowels, the inventors have formulated the following algorithms for use within the voice analysis tool.

1. Unvoiced syllable-final regions in the speech waveforms of sonorants such as vowels, liquids, glides and nasals are omitted. Omitting such unvoiced regions saves storage space and provides for an optimal speech synthesis rate. (Phrase-final syllable endings are left intact.)

2. Any pauses in between the words of a phrase are omitted. This omission saves storage space.

3. Creakiness is omitted in order to create a smoother speech output. The unvoiced closure of stops are omitted in the mark-ups. At speech synthesis runtime, silent headers for the stops are manufactured. This omission during mark-up of the phrases also saves storage space.

4. The use of Reflection Coefficient calculations instead of Formant calculations to determine transitional boundaries between voiced and unvoiced regions. These are much easier to compute than Formants, while yielding more information. Accurately defining the onset and end of “true voicing” is crucial to the determination of syllable boundaries.

5. Accurate detection of: frication, pitch, RMS Energy, stop bursts, and silence.

6. Detecting a small but significant drop in voicing within a voiced region.

7. Detection of vowels within a long sequencing of voicing, including any minimal power regions separating them.

8. Finding a region of minimal power embedded within a larger region.

9. Nasal detection using Reflection Coefficient info as well as power stats.

10. The blotting out of low-energy transitional information between the end of a syllable and the start of the next one. This makes each syllable more sharable in other contexts.

The voice analysis tool also has a concatenation mode in which the marked-up syllables can be concatenated to demonstrate their accuracy. (1) A “Narrate” feature was instated into the tool which allows the consecutive concatenation of phrases instead of having them read out one by one. (2) During the Narrate mode, a feature that allows pressing a button to automatically place incorrect concatenations into a text file was installed. This saves time by not having to stop the concatenation process and manually write down the errors.

Instead of using the mouse to zoom in on certain parts of the phrase during mark-up, a zoom button was installed which allows zooming out several times for easy review of the intricate speech waveforms. A separate button allows zooming back in. Using zoom buttons instead of the mouse saves wear and tear on the wrist since thousands of phrases must be reviewed.

An example is a case where syllables in a phrase “MirrorLight Place” are marked-up. In this example, the syllable corresponds to “Mirror” is a supersyllable noted above.

A voice waveform can be shown that is a combination of various frequency components (fundamental and harmonics) and their amplitudes that change depending on the tone, stress, and type of the voice, etc. A pitch plot shows changes of fundamental frequency. If the phrase is spoken by the same tone (frequency), the plot will be flat in a horizontal direction. If the plot goes higher, it means that the tone (frequency) of the recorded voice becomes higher. The reflection coefficients f2 and f3 help to find a boundary between two syllables. In this example, although the reflection coefficient f2 does not show any significant change between the syllables corresponding to “Mirror” and “Light”, the reflection coefficient f3 shows a sharp change between the syllables, which signifies the syllable boundary.

As described herein, the present invention includes both an apparatus for and a method of text to speech synthesis.

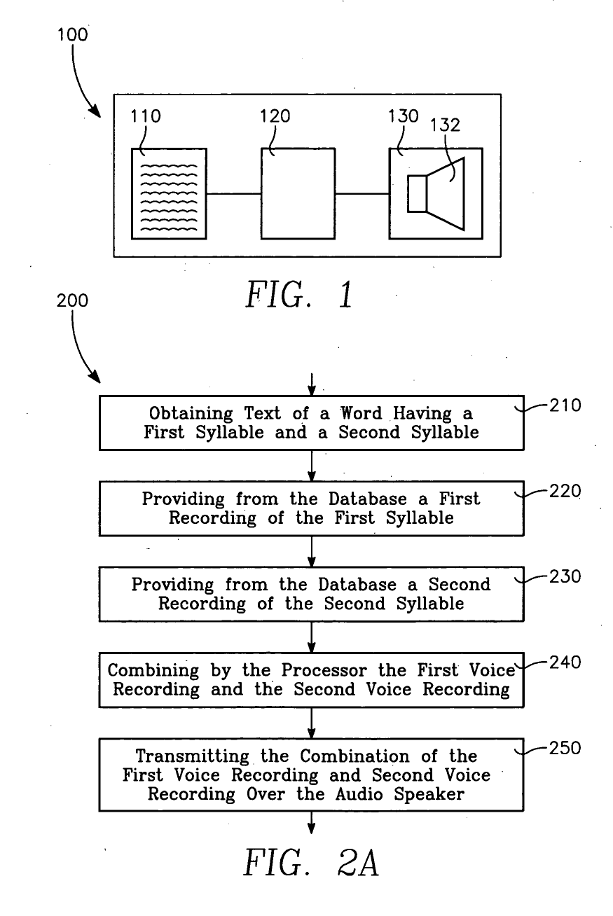

Depending on the embodiment, the apparatus can be a vehicle navigation system 100 which includes a database 110, a processor 120 and a speaker 130, as shown in FIG. 1. The database 110 can be used to store map data including text of various features, such as names of roads, towns, highways, points of interest, stores, gas stations, restaurants, and the like. Also, the database 110 can store prior voice recordings of speech or portions of speech. Of course both the text and voice recordings stored in the database can be used with the text to speech synthesis. Physically, the database 110 can be stored on any acceptable media, such as a hard drive, ram memory, cd rom, dvd, flash memory, or the like. The database 110 is connected to the processor 120 which functions to produce speech utilizing data stored on the database 110.

The processor 120 is capable of retrieving from the database 110 information, such as map data and voice recording files. Such information can include multi-syllable text associated with various elements of the map.

The processor 120 can also generate navigation commands for aiding the navigation of the vehicle. These generated commands typically include textual statements, such as ‘turn right’ or ‘exit ahead’. Also, the processor 120 can utilize the recorded voice files from the database 110 and arrange and/or concatenate them together to correspond to text obtained from the database or generated by the processor 120 to synthesize speech. The processor 120 can then transmit the synthesized speech by the speaker 130 attached thereto. The synthesized speech can be a portion of a navigation command, were the remaining portion is derived from a separate source (such a prerecorded file).

The operation of the processor can, in embodiments, include the method of the invention set forth herein. For example, the processor 120 can perform the method 200, which is described in detail below.

The processor 120 can be any of a variety of computer central processing units (CPUs), including those commercially available. The processor 120 as a CPU can execute the methods set forth herein (including method 200) by way of a software program it loads and runs.

In at least one embodiment of the present invention, the processor 120 performs the steps of generating text of a word having at least a first syllable and a second syllable, obtaining from the database a first voice recording of the first syllable and a second voice recording of the second syllable, combining the first voice recording and the second voice recording; and transmitting the combination of the first voice recording and the second voice recording over the audio speaker 130. While in embodiments this combination of recordings can effectively match a single recording of a verbal rendition the entire word, there are separate embodiments where the sound produced by the combination is merely similar to a verbal rendition of the word. In other words, the quality of the sound produced can vary in embodiments of the invention.

The operation of processor 120 can also include a step of determining the context of the syllables by using the text of the word to define whether each of the syllables are preceded or followed by a vowel or a consonant. Then the processor can retrieve from the database 110 voice recording files which for each of the syllables which match the context in which they exist in the subject word. The inventors here have found that such an approach tends to provide improved quality of the produced sounds.

In other embodiments the present invention is a method of text to speech synthesis. This method can be used in a vehicle navigation system to, among other things, verbally announce data related to the map or maps of the system and/or to the navigation functions of the system. For example, the method is capable of converting the textual name of a road that the user's vehicle is traveling on to a verbal announcement. Likewise, the method can be used to convert the text of a navigation command, such as ‘Turn left on Grammecy place’ into a verbal statement.

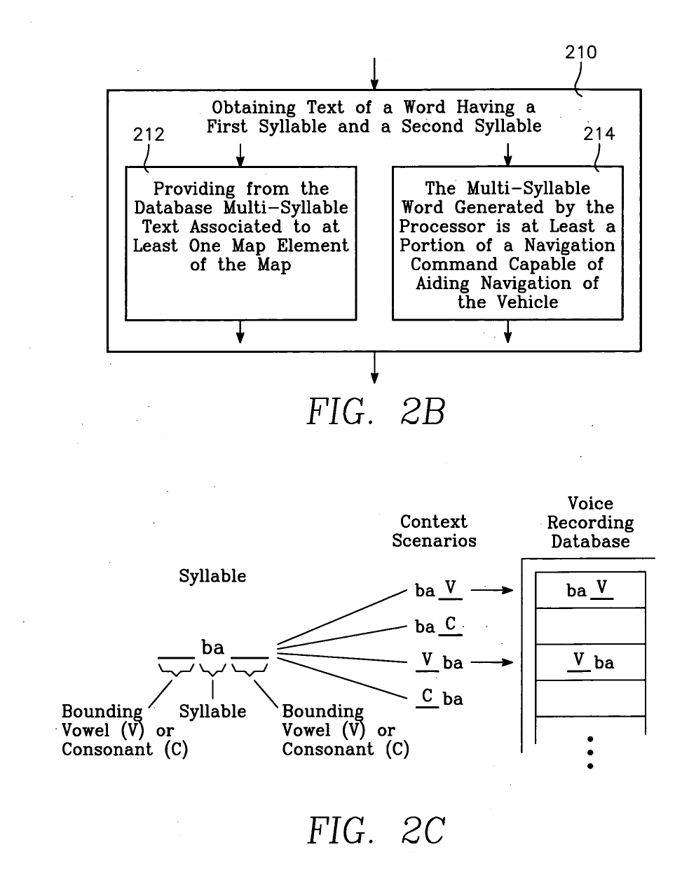

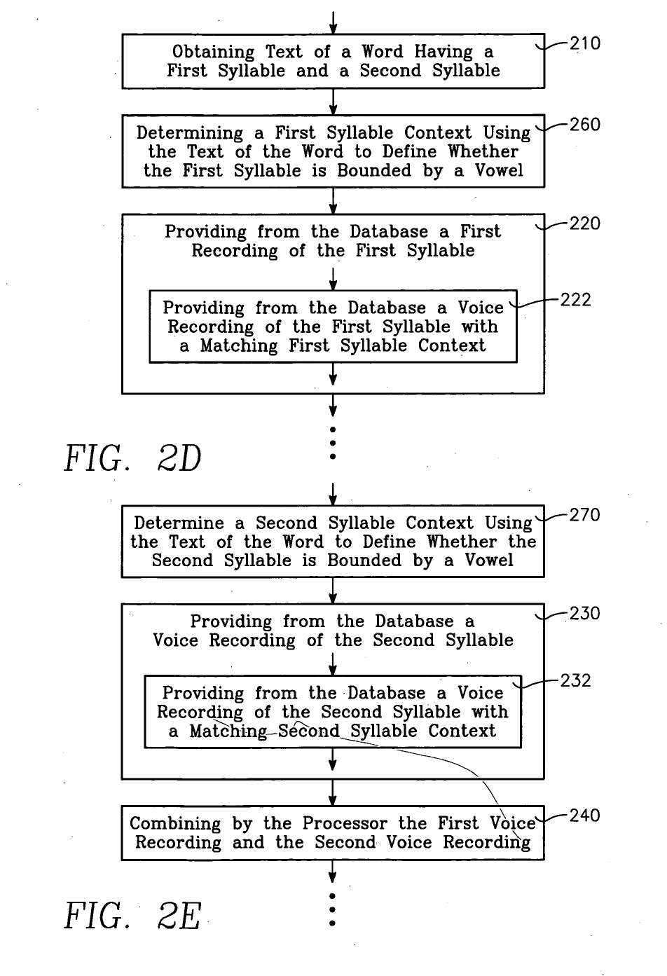

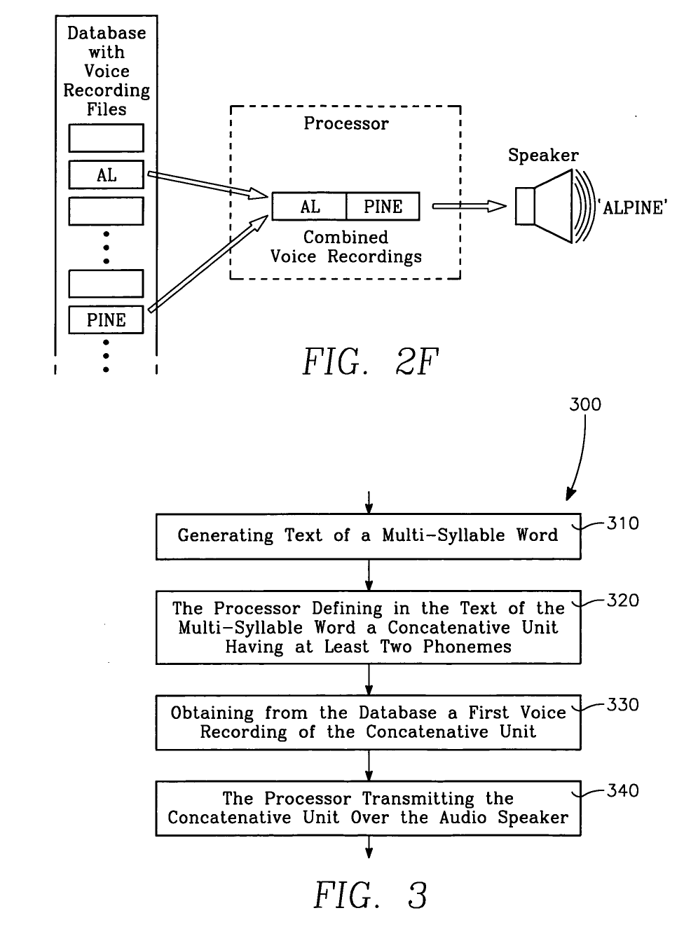

As shown in FIG. 2A, a method of text to speech synthesis 200 includes obtaining text of a word having a first syllable and a second syllable 210, providing from the database a first voice recording of the first syllable 220, providing from the database a second voice recording of the second syllable 230, combining by the processor the first voice recording and the second voice recording 240, and transmitting the combination of the first voice recording and the second voice recording over the audio speaker 250.

In embodiments the first step of the method 200 is obtaining text of a word having a first syllable and a second syllable 210. The obtaining of the text of the multi-syllable word can be done in any of a variety of ways. Generally, the multi-syllable word can be obtained from being stored on the database or it can be generated by the operation of the processor.

In embodiments, the database can store one or more maps which are used by the vehicle navigation apparatus to, among other things, located the vehicle, provide an aid to the guidance of the vehicle, and to provide map related information to the user. Included in or otherwise associated with the map can be text which can include single and multi-syllable words. Examples of such words can include map elements such as street names, towns, points of interest, etc.. As shown in FIG. 2B, the step 210 of the method 200 can include providing from the database multi-syllable text associated to at least one map element of the map 212.

The multi-syllable word used in the method 200 for speech synthesis can also in embodiments be generated by the processor of the vehicle navigation system. The multi-syllable word can be generated for any of a variety of reasons including as part of the operation of navigation system, as part of a navigation command mage by the system, or the like. Navigation commands can be issued by the processor to be broadcasted by the attached speaker to aid the driver of the vehicle in navigating the vehicle. As shown in FIG. 2B, the step 210 of the method 200 can include that the multi-syllable word being generated by the processor is at least a portion of a navigation command capable of aiding navigation of the vehicle 214.

After the text of a word is obtained in step 210, the next step of the method can be providing from the database a first voice recording of the first syllable 220, as shown in FIG. 2A. During this step a prerecorded voice recording of a syllable is retrieved from the database to be used by the processor to create the synthesized speech. The syllable retrieved will be that associated or indexed to the first syllable of the subject multi-syllable word. In embodiments, the processor first searches the database for a voice recording file matching the first syllable and then loads from the file from the database to the processor's memory for further processing, such as concatenating with one or more additional voice recording files of other syllables. Such processor memory can be a cache of a CPU.

In some embodiments of the invention, the syllables stored in the database with context of their position within a word. This context can include whether the syllable is bounded by either a vowel or a consonant and/or which side of the syllable the bounding occurs. For example, as shown in FIG. 2C, the syllable can be bound on either side by either a vowel or a consonant, which provides at least four different context scenarios. Depending on the embodiment of the invention all or a select number of these scenarios can be recorded and saved in the database. The inventors have found that to maximize the use of the limited storage space in a database of a vehicle navigation device that only those syllables bounded by vowels should have an associated voice recording file maintained in the database. The inventors have found that this is because more linguistic coloring occurs across vocalic boundaries than across consonantal boundaries. Clearly, in embodiments the amount of inclusion of the context scenarios into the database can vary depending on the specific requirements of the application.

FIG. 2D shows a portion of the method 200 in an embodiment with an additional step of determining a first syllable context using the text of the word to define whether the first syllable is bounded by a vowel 260 and with the step of providing from the database a first voice recording of the first syllable 220 includes providing from the database a voice recording of the first syllable with a matching first syllable context 222. The first syllable context can be whether the first syllable is preceded or followed by a vowel or a consonant, depending on the particular embodiment of the invention.

As shown in FIG. 2A, the next step in the method 200 is providing from the database a second voice recording of the second syllable 230. This step is similar to the step 220 as described herein, as it also functions to retrieve a voice recording associated with a syllable from the database. The voice recording of the second syllable is then used in conjunction with the recording of the first syllable by the processor to create the synthesized speech.

In embodiments, the processor first searches the database for a voice recording file matching the second syllable and then loads from the file from the database to the processor's memory for further processing.

As with the first syllable, in some embodiments of the invention, the syllables stored in the database include the context of their position within a word, such as being bounded by either a vowel or a consonant. Again, an example of this bounding and resulting storage is shown in FIG. 2C. Also, again, in some embodiments, the amount of inclusion of the context scenarios into the database can vary depending on the specific requirements of the application.

FIG. 2E shows a portion of the method 200 in an embodiment with an additional step of determining a second syllable context using the text of the word to define whether the second syllable is bounded by a vowel 270 and with the step of providing from the database a second voice recording of the second syllable 230 includes providing from the database a voice recording of the second syllable with a matching second syllable context 232. The first syllable context can be whether the first syllable is preceded or followed by a vowel or a consonant, depending on the particular embodiment of the invention.

The next step for the method 200 is combining by the processor the first voice recording and the second voice recording 240. During this step the processor functions to concatenate the two voice recordings together to form a combined sound recording which can then be transmitted by the processor through the speaker as synthesized speech or a portion of synthesized speech. That is, the combination of the first and second voice recordings can result in a verbal rendition of a word (e.g. two syllable word), or of just a portion of a word.

In some embodiments, the processor combines more than the first and the second voice recordings to form a desired word (e.g. words with more that two syllables) to be synthesized and may even combine enough recordings to form several desired words to achieve a synthesis of a desired phase or statement. Of course, in the process of synthesizing more that one word, the process will also add blank portions to define the separate words.

FIG. 2F shows a process as set forth in the step 240 of combining a two voice recordings to obtain a desired word to be synthesized.

As shown in FIG. 2A, the next step in the method 200 is transmitting the combination of the first voice recording and the second voice recording over the audio speaker 250. During this step the combination of the first voice recording and the second voice recording is transmitted over the audio speaker to produce an expression of sound which is at least substantially similar to a verbal rendition of the word. That is, the produced sound does not have to match a verbal rendition of the entire word, or portion of the word, but since it is made from a combination separate recording of portions of the word, it can be similar sounding to a rendition of the entire word. In some embodiments the produced sound is substantially similar to a separate entire verbal rendition of the subject word.

In certain embodiments of the present invention the method performs the text to speech synthesis utilizing concatenative units which are at least larger than a single phoneme, a single diphone or a single semi-diphone. These concatenative units can be syllables, syllables in context, and/or supersyllables. Syllables are comprised of phonemes.

As noted herein, a text to speech synthesis system using a single phoneme as the concatenative unit will involve acoustic mismatches between vowels and consonants within the syllable. For example, such a system could concatenate the two phonemes “b” and “u” to produce the word “boo”. However, unless specifically designed not to do so, it could conceivably concatenate with “b” a vowel “u” that originally was recorded with a preceding “d”. Since the second formant of the naturally produced “bu” is very different from the second formant of the naturally produced “du”, the synthesized output of “bu” would not sound exactly like the original naturally produced “bu”. The text to speech synthesis system of the present invention avoids this problem since the system uses the syllable as the concatenative unit. The text to speech synthesis system would produce the synthesized syllable “bu” just as it was recorded since it was never split into phonemes. Consequently, the present invention avoids the problem of mismatches within syllables.

Using a syllable in context as the concatenative unit avoids any problems arising from syllable boundary coarticulation. With the syllable in context, stored on the database with syllables is the positioning of the syllable relative to adjacent vowels and/or consonants. For example, the context can be if the syllable is bounded by a vowel on at least one side. Also the possible linguistic context of the syllable may be encoded as well. The syllable-in-context construct of using the English syllable as the basic concatenative unit along with its very large inventory of linguistic context provides for a smooth synthetic output.

Storing only syllables with vocalic boundaries in the database does not address the possibility of coarticulation mismatches across consonantal syllabic boundaries. Using the supersyllable as the concatenative unit functions to have syllables defined which include more than one vowel nucleus. This is done when the syllables involve consonants that are particularly prone to coloring their adjacent linguistic context. For example, including two vowel nuclei in the concatenative unit, will be a supersyllable.

As shown in FIG. 3A, in at least one embodiment the method 300 includes generating text of a multisyllable word 310, the processor defining in the text of the multisyllable word a concatenative unit having at least two phonemes 320, obtaining from the database a first voice recording of the concatenative unit 330, and the processor transmitting the concatenative unit over the audio speaker 340.

The first step of the method 300 is generating text of a multisyllable word 310. This step can be performed by a variety of ways including providing the multisyllable word from operation of the processor or from retrieval of information from the database. For example, the processor may operate to create a command to aid in the navigation of the vehicle (e.g. ‘turn left ahead on Gramercy Place’), with the multisyllable word being a portion of the command. Retrieval from the database can include obtaining a multisyllable word which is associated to an element of the map (e.g. road name, town, highway, etc.).

The next step of the method 300 is the processor defining in the text of the multisyllable word a concatenative unit having at least two phonemes 320. During this step the processor analyzes the text of the multisyllable word and defines one or more concatenative units within the word. Depending on the embodiment the concatenative unit can vary and may, for example, be a syllable, a syllable in context or a supersyllable as defined herein. The particular definition of the concatenative unit may be chosen prior to operation of the step or may be chosen during operation of the step based on a set of predefined rules (e.g. syllable, syllable in context, supersyllable) for each of the types of concatenative units as set forth herein.

In embodiments the defined concatenative unit must contain more than a single phoneme. As noted, the inventors have found that to avoid or at least reduce acoustic mismatches between vowels and consonants between concatenative units that the concatenative unit must contain at least two phonemes and in some embodiments the concatenative unit must at least be a syllable.

The next step in the method 300 is obtaining from the database a first voice recording of the concatenative unit 330. Depending on the embodiment, during this step the processor may search the database to locate a voice recording which is indexed to the concatentative unit defined in the prior step. Then the processor loads or at least starts the loading of the voice recording into the processor, prior to transmitting the recording over the audio speaker. The voice recording in the database can be in any of a variety of known formats, such as a .wav file, or the like.

The final step of the method 300 is the processor transmitting the concatenative unit over the audio speaker 340. Depending on the embodiment the conversion of the voice recording and the transmission over the speaker can be achieved by any of a variety of know processes.

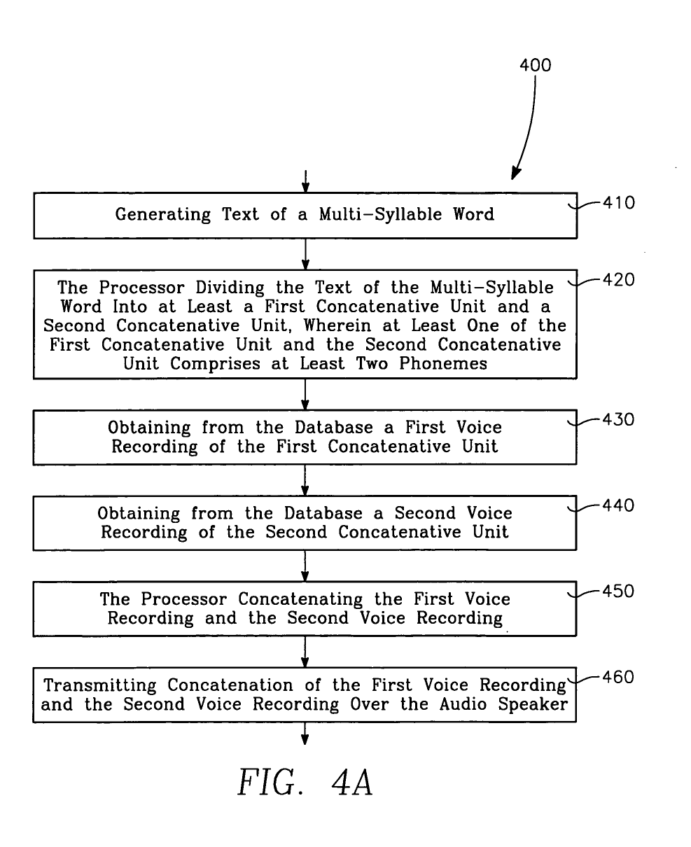

FIG. 4 shows another embodiment of the method of the present invention and includes the steps of generating text of a multisyllable word 410, the processor dividing the text of the multisyllable word into at least a first concatenative unit and a second concatenative unit, wherein at least one of the first concatenative unit and the second concatenative unit comprises at least two phonemes 420, obtaining from the database a first voice recording of the first concatenative unit 430, obtaining from the database a second voice recording of the second concatenative unit 440, the processor concatenating the first voice recording and the second voice recording 450, and transmitting the concatenation of the first voice recording and the second voice recording over the audio speaker 460.

The first step of method 400 can be generating text of a multisyllable word 410. This step can include generating the multisyllable word from operation of the processor, such as creating a navigation command, or the multisyllable word can be generated from retrieval of information from the database, such a word associated with a map element or the like.

The next step of the method 400 is the processor dividing the text of the multisyllable word into at least a first concatenative unit and a second concatenative unit, wherein at least one of the first concatenative unit and the second concatenative unit comprises at least two phonemes 420. At least one of the concatenative units must be more than a single phoneme and in some embodiments both of the concatenative units (or all of the units for more than two units) must each have more than a single phoneme. As noted herein, this is done to avoid or at least reduce acoustic mismatches between vowels and consonants between concatenative units.

The division of the multisyllable word into concatenative units can be performed in a variety of ways. One such way is to define the concatenative unit as a syllable of the word. In this matter the associated voice recording will contain the verbal rendition of the entire syllable, eliminating the acoustic mismatches between vowels and consonants within the syllable which would otherwise occur if the concatenative units were defined as phonemes.

Another way of defining the division of the multisyllable word is by setting the concatenative unit as a syllable in context. While defining the concatenative unit as syllable addresses the problem of acoustic mismatches between vowels and consonants within the syllable, it may not eliminate acoustic mismatches across the syllable boundaries when more than syllable is combined. To avoid or limit syllable boundary coarticulation if the syllable is bounded by a vowel on at least one side, its possible linguistic context is encoded as well. That is, the syllable in it context is first defined as the concatenative unit and then a matching voice recording of that same syllable in the same context is retrieved from the database. Depending on the embodiment, the context can include whether the syllable is bounded (either side) by either a vowel or a consonant.

However, in some embodiments, to meet data storage limitations of the database of vehicle navigation device, the linguistic context for each syllable is limited to only syllables whose boundaries consist of vowels, but not consonants. The inventors have found that improved results are obtained by selecting only linguistic context related to vowel boundaries, because more linguistic coloring occurs across vocalic boundaries than across consonantal boundaries. For example, the syllable “ba” would have linguistic context encoded for the vowel “a”, but not for the consonant “b”. The syllable-in-context construct of using the English syllable as the basic concatenative unit along with its very large inventory of linguistic context provides for a smooth synthetic output. As such in embodiments, the syllable context information is encoded for syllables beginning or ending with a vowel.

Even with syllable context information being encoded for syllables beginning or ending with a vowel, there is still the possibility of coarticulation mismatches across consonantal syllabic boundaries. To address such problems the concatenative unit can also in embodiments be defined as a supersyllable. A supersyllable can be a created syllable which includes more than one vowel nucleus. This can be done for syllables which involve consonants that are particularly prone to coloring their adjacent linguistic context.

In some embodiments the supersyllable is employed where syllable has two consecutive vowels, where one vowel is unstressed due to a heavy linguistic coloring between the two vowels, so that there is no exact acoustic diving line between the two vowels. In other embodiments, the multisyllable word has a first vowel/consonant/second vowel structure, and the first concatenative unit includes the first vowel and the second concatenative unit includes the consonant and second vowel.

After the concatenative units have been defined the next step in the method 400 is obtaining from the database a first voice recording of the first concatenative unit 430. As noted, the database contains a set of voice recordings of each of the different concatenative units, which can be in any of a variety of acceptable formats, such as .wav files. The database also indexes each of these recordings to identify the file, such as by a text title matching the concatenative unit. During this step the processor searches the database to locate a voice recording. The processor then loads or at least starts the loading of the first voice recording into the processor (e.g. the processor cache), prior concatenating with the second recording for eventual transmission of the combined recording over the audio speaker.

The next step is obtaining from the database a second voice recording of the second concatenative unit 440. This step is effectively a repeat of the step 430 except that the second voice recording obtained.

Then, the processor concatenates the first voice recording and the second voice recording 450 to form a verbal rendition of either a multisyllable word or at least a portion of a multisyllable word. A portion of a word may be formed when the subject word has more than two syllables. In such cases, additional obtaining steps would be performed to combine enough voice recordings to form the multisyllable word.

The concatenation of the voice files can be performed in any of a variety of known processes including playing one immediately after the other file or otherwise merging or joining the files.

The final step of the method 400 is transmitting the concatenation of the first voice recording and the second voice recording over the audio speaker 460. As with similar step set forth herein, this transmission step can be performed by any of a variety of known processes.

Although this invention has been disclosed in the context of certain embodiments and examples, it will be understood by those or ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Furthermore, the processes described herein may be embodied in hardware, in a set of program instructions-software, or both, i.e., firmware. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A method of text to speech synthesis in a vehicle navigation system having a database, a processor connected to the database and an audio speaker connected to the processor, the method comprising:
obtaining text of a word having a first syllable and a second syllable;
providing from the database a first voice recording of the first syllable;
providing from the database a second voice recording of the second syllable;
combining by the processor the first voice recording and the second voice recording; and
transmitting the combination of the first voice recording and the second voice recording over the audio speaker.

2. The method of claim 1, wherein the database comprises a map having at least one map element and having multi-syllable text associated to the at least one map element of the map and wherein obtaining text of a word having a first syllable and a second syllable comprises providing from the database multi-syllable text associated to at least one map element of the map.

3. The method of claim 1, wherein combining by the processor the first voice recording and the second voice recording and transmitting the combination of the first voice recording and the second voice recording over the audio speaker provides an expression of sound at least substantially similar to a verbal rendition of the word.

4. The method of claim 1, wherein the processor is capable of generating text of a multi-syllable word and wherein obtaining text of a word having a first syllable and a second syllable comprises generating text of a multi-syllable word by the processor.

5. The method of claim 4, wherein the multi-syllable word generated by the processor is at least a portion of a navigation command capable of aiding navigation of the vehicle.

6. The method of claim 1, further comprising determining a first syllable context using the text of the word to define whether the first syllable is bounded by a vowel; and wherein providing from the database a first voice recording of the first syllable comprises providing from the database a voice recording of the first syllable with a matching first syllable context.

7. The method of claim 6, further comprising determining a second syllable context using the text of the word to define whether the second syllable is bounded by a vowel; and wherein providing from the database a second voice recording of the second syllable comprises providing from the database a voice recording of the second syllable with a matching second syllable context.

8. The method of claim 1, further comprising determining a first syllable context using the text of the word to define whether the first syllable is preceded or followed by a vowel; and wherein providing from the database a first voice recording of the first syllable comprises providing from the database a voice recording of the first syllable with a matching first syllable context.

9. The method of claim 6, further comprising determining a second syllable context using the text of the word to define whether the second syllable is preceded or followed by a vowel; and wherein providing from the database a second voice recording of the second syllable comprises providing from the database a voice recording of the second syllable with a matching second syllable context.

10. A vehicle navigation apparatus comprising:
a database having voice recordings corresponding to word syllables;
an audio speaker; and
a processor connected to the database and the speaker, wherein the processor performs:
generating text of a word having at least a first syllable and a second syllable;
obtaining from the database a first voice recording of the first syllable and a second voice recording of the second syllable;
combining the first voice recording and the second voice recording; and
transmitting the combination of the first voice recording and the second voice recording over the audio speaker.

11. The vehicle navigation apparatus of claim 10, wherein the database further comprises a map having at least one map element and having multi-syllable text associated to the at least one map element of the map and wherein generating text of a word having a first syllable and a second syllable comprises providing from the database multi-syllable text associated to at least one map element of the map.

12. The vehicle navigation apparatus of claim 10, wherein combining the first voice recording and the second voice recording and transmitting the combination of the first voice recording and the second voice recording over the audio speaker provides an expression of sound at least substantially similar to a verbal rendition of the word.

13. The vehicle navigation apparatus of claim 10, wherein the processor is capable of generating text of a multi-syllable word and wherein obtaining text of a word having a first syllable and a second syllable comprises generating text of a multi-syllable word by the processor.

14. The vehicle navigation apparatus of claim 13, wherein generating text of a word having a first syllable and a second syllable is generating a word which is at least a portion of a navigation command capable of aiding navigation of the vehicle.

15. The vehicle navigation apparatus of claim 10, wherein the processor further performs determining a first syllable context using the text of the word to define whether the first syllable is preceded or followed by a vowel and determining a second syllable context using the text of the word to define whether the second syllable is preceded or followed by a vowel; wherein obtaining from the database a first voice recording of the first syllable comprises obtaining from the database a voice recording of the first syllable with a matching first syllable context; and wherein obtaining from the database a second voice recording of the second syllable comprises obtaining from the database a voice recording of the second syllable with a matching second syllable context.

16. A method of text to speech synthesis in a vehicle navigation system having a database, a processor connected to the database and an audio speaker connected to the processor, the method comprising:
generating text of a multisyllable word;
the processor defining in the text of the multisyllable word a concatenative unit having at least two phonemes;
obtaining from the database a first voice recording of the concatenative unit; and
the processor transmitting the concatenative unit over the audio speaker.

17. The method of claim 16, wherein the concatenative unit is a syllable.

18. A method of text to speech synthesis in a vehicle navigation system having a database, a processor connected to the database and an audio speaker connected to the processor, the method comprising:
generating text of a multisyllable word;
the processor dividing the text of the multisyllable word into at least a first concatenative unit and a second concatenative unit, wherein at least one of the first concatenative unit and the second concatenative unit comprises at least two phonemes;
obtaining from the database a first voice recording of the first concatenative unit;
obtaining from the database a second voice recording of the second concatenative unit;
the processor concatenates the first voice recording and the second voice recording; and
transmitting the concatenation of the first voice recording and the second voice recording over the audio speaker.

19. The method of claim 18, wherein the first concatenative unit is a syllable.

20. The method of claim 19, wherein the second concatenative unit is a syllable.

21. The method of claim 18, wherein the first concatenative unit has a more than one vowel nucleus.

22. The method of claim 21, wherein the second concatenative unit has a more than one vowel nucleus.

23. The method of claim 18, wherein the first concatenative unit has a more than one vowel nucleus and at least one consonant coloring the adjacent linguistic context.

24. The method of claim 18, wherein the first concatenative unit has two consecutive vowels, where one vowel is unstressed due to a heavy linguistic coloring between the two vowels, so that there is no exact acoustic diving line between the two vowels.

25. The method of claim 18, wherein the multisyllable word has a first vowel/consonant/second vowel structure, and wherein first concatenative unit includes the first vowel and the second concatenative unit includes the consonant and second vowel.
